(19) United States
(12) Patent Application Publication
(10) Pub. No.: US 2004/0161156 A1
(43) Pub. Date: Aug. 19, 2004

(54) Image processing apparatus, method, program and medium storing image processing program

(76) Inventor: Akio Matsubara, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/734,805

(22) Filed: Dec. 11, 2003

(30) Foreign Application Priority Data
Dec. 27, 2002 (JP) 2002-380039

(51) Int. Cl. G06K 9/36

(52) U.S. Cl. 382/232

(57) ABSTRACT

An image processing technique for enabling the extraction of a region of interest from non-compressed files and compressed files in a format other than the JPEG 2000 format is disclosed. Specifically, a compression unit to perform a compression process on an image using the JPEG 2000 format and a decompression unit to perform a decompression process on an image compressed using a format other than the JPEG 2000 format are provided. The designation of a region of interest for an image file stored in a storage region is allowed, and it is determined whether the image file is a non-compressed file or a compressed file in a format other than the JPEG 2000 format. When it is determined that the image file is a non-compressed file, the file is compressed by the compression unit. When it is determined that the image file is a compressed file in a format other than the JPEG 2000 format, the file is decompressed by the decompression unit before being compressed by the compression unit. Then, blocks corresponding to the designated region of interest are extracted from the compressed image and output.

The present application claims priority to the corresponding Japanese Application No. 2002-380039, filed on Dec. 7, 2002, the entire contents of which are hereby incorporated by reference.

### BACKGROUND OF THE INVENTION

1. Field of the Invention

The present invention relates to an image processing apparatus that performs image data compression/decompression, an image processing method, an image processing computer program, and a storage medium that stores this image processing computer program. The present invention may, for example, be applied to image handling apparatuses such as a mobile phone, a digital camera, an Internet browser, a medical apparatus, or a satellite communication apparatus; device drivers such as a printer driver, and various application programs.

2. Description of the Related Art

In recent years and continuing, with the development of image input/output technologies, there is a growing demand for higher image resolution. Taking the digital camera as an example of an image input apparatus, the price of a high performance charge coupled device (CCD) that has 3 million or more pixels is going down and this device is therefore starting to be widely used even in products that are within a commercially popular price range. Higher resolution and price reduction can also be seen in the fields of image output apparatuses and image display apparatuses, where hard-copy technologies applied to printers such the laser printer and the ink jet printer, for example, as well as soft-copy technologies applied to displays such as the CRT and LCD, for example, are rapidly developing.

With the introduction of such high-performance low-priced image input/output products to the market, high resolution images are becoming increasingly popular. Thus, in the future, it is expected that high resolution images will be in demand for all kinds of applications.

Under such circumstances, demand for improved compression/decompression technologies to facilitate handling of high resolution images is undoubtedly on the rise as well. Accordingly, image compression technologies that satisfy such demand have been developed in the conventional art. An example of such technology is the so-called JPEG 2000 technology, which enables processing of a high resolution image by subdividing the image into small units upon compression so that a high quality image can be decoded from the compressed image despite the use of a high compression rate.

In the field of image processing, there is a concept called region of interest. The region of interest may, for example, correspond to a region to which a user pays particular attention. Thus, in the conventional art, for example, an image processing technique may be used in which the region of interest is displayed in color and the other regions are displayed in black and white so that the region of interest may stand out (e.g., refer to Japanese Laid-Open Patent Publication No.01-270173, and Japanese Laid-Open Patent Publication No.06-114059).

A concept called ROI (Region Of Interest) is also provided in JPEG 2000 so that the compression rate of the ROI can be set lower than the compression rate of other regions thereby enabling the ROI to be decoded with high definition.

In JPEG 2000, image data are divided into block units called tiles and precincts. In this way, desired processes on the region of interest can be easily performed in block units of such tiles and precincts. In other words, JPEG 2000 is an image compression format to which the concept of ROI can be easily introduced.

Such advantage of the JPEG 2000 becomes apparent when image data compressed using JPEG 2000 are exchanged in image data communications. Namely, by transmitting and receiving just the region of interest in image data communications, the communication speed of delivery can be increased, the memory consumption of the transmission/reception side can be deceased, and the load on the data communications network can be reduced since traffic within the network will be reduced.

On the other hand, when the image data correspond to an uncompressed file that is described in a bitmap or TIFF format, or when the image data are a compressed file that is compressed using a format other than JPEG 2000, the concept of ROI is generally not provided for within the file format.

Thus, for such uncompressed files or compressed files that are compressed using formats other than JPEG 2000, it is difficult to extract the region of interest for further handling. Thereby, the resulting effects will be the opposite of the above-described advantageous effects of using JPEG 2000. Namely, in image data communications, it is not possible to transmit/receive just the region of interest and, instead, all the image data have to be transmitted/received. This inevitably leads to various inconveniences such as a decrease in the communication delivery speed, an increase in the memory consumption of the transmitting/receiving side, or an increase in the load on the data communications network due to the increase of traffic within the network.

### SUMMARY OF THE INVENTION

An image processing apparatus, method, program and medium storing an image processing program are described. In one embodiment, the image processing apparatus comprises a compression unit to perform a compression process on an image using a JPEG 2000 format; a decompression unit to perform a decompression process on an image compressed using a format other than the JEPG 2000 format; a designation allowing unit to allow a designation of a region of interest for an image file stored in a storage region; a determination unit to determine that the image file corresponds to at least one of a non-compressed file and a compressed file compressed using a format other than the JEPG 2000 format; a compression execution unit to compress the image file using the JEPG 2000 format by use of the compression unit in a case where the determination unit determines that the image file corresponds to a non-compressed file, and decompressing the image file by use of the decompression unit before compressing the image file using the JPEG 2000 format by use of the compression unit in a case where the determination unit determines that the image file corresponds to a compressed file compressed using a format other than the JPEG 2000 format; and an extraction output unit to extract from the compressed image file compressed by the compression unit a plurality of blocks corresponding to a region of interest designated by the designation allowing unit, and outputting the extracted image file.

### BRIEF DESCRIPTION OF THE DRAWINGS

FIG. 1 is a block diagram illustrating basic JPEG 2000 algorithms;

FIG. 2 is a diagram illustrating an example of components into which a color image corresponding to a source image is divided;

FIG. 3 is a diagram illustrating sub bands at each decomposition level in a case where the decomposition level is set to 3;

FIG. 4 is a diagram illustrating exemplary precincts;

FIG. 5 is a schematic diagram illustrating a process of decomposing a two-dimensional wavelet coefficient value obtained from a two-dimensional wavelet transform into bit plane units, and assigning order to the bit planes for each pixel or code block;

FIG. 6 is a data diagram illustrating an example of a code stream of coded image data;

FIG. 7 is a block diagram illustrating the functions of a server corresponding to an image processing apparatus according to an embodiment of the present invention; and

FIG. 8 is a flowchart illustrating the flow of processes performed by the server corresponding to the image processing apparatus.

### DESCRIPTION OF THE PREFERRED EMBODIMENTS

An embodiment of the present invention enables the extraction of the region of interest even from uncompressed files or compressed files that have been compressed using formats other than JPEG 2000 for viewing and other processes.

One embodiment of an image processing apparatus includes: a compression unit to perform a compression process on an image using a JPEG 2000 format; a decompression unit to perform a decompression process on an image compressed using a format other than the JEPG 2000 format; a designation allowing unit to allow a designation of a region of interest for an image file stored in a storage region; a determination unit to determine that the image file corresponds to a non-compressed file or a compressed file compressed using a format other than the JEPG 2000 format; a compression execution unit to compress the image file using the JEPG 2000 format by use of the compression unit in a case where the determination unit determines that the image file corresponds to a non-compressed file, and decompressing the image file by use of the decompression unit before compressing the image file using the JPEG 2000 format by use of the compression unit in a case where the determination unit determines that the image file corresponds to a compressed file compressed using a format other than the JPEG 2000 format; and an extraction output unit to extract from the compressed image file compressed by the compression unit blocks corresponding to a region of interest designated by the designation allowing unit and outputting the extracted image file.

When the determination unit determines that the image file is a non-compressed file, the image file is compressed using the JPEG 2000 format by use of the compression unit, and when the determination unit determines that the image file is a compressed file compressed using a format other than the JEPG 2000 format, the image file is decompressed by use of the decompression unit before being compressed using the JPEG 2000 format by means of the compression unit. Then, the extraction output unit extracts from the image file compressed by the compression unit blocks corresponding to the region of interest designated by the designation allowing unit and outputs the extracted image file. In this way, image data can be handled in units of the blocks corresponding to the region of interest.

Further, the image processing apparatus of the present invention may allow various limitations with respect to the compression unit, the decompression unit, and the extraction output unit In one embodiment, the compression unit performs a lossless compression process on the image. In another embodiment, the compression unit performs a lossy compression process on the image. In another embodiment, the compression unit performs a wavelet transform process using a 5×3 filter bank. In another embodiment, the compression unit performs a wavelet transform process using a 9×7 filter bank. In another embodiment, the decompression unit performs a decompression process on an image compressed using a DCT (Discrete Cosine Transform) coding format as the format other than the JEPG 2000 format. In another embodiment, the extraction output unit extracts and outputs the blocks in units of tiles. In another embodiment, the extraction output unit extracts and outputs the blocks in units of precincts. In another embodiment, the extraction output unit adjusts a resolution of the extracted image file to be output. In another embodiment, the extraction output unit outputs the extracted image file as a monochrome image. In another embodiment, the extraction output unit successively outputs layers included in a code stream that is generated in the compression process performed by the compression unit starting from an upper layer.

One embodiment of an image processing method is realized using, as a hardware resource, a computer having a compression unit to perform a compression process on an image using a JEPG 2000 format, and a decompression unit to perform a decompression process on an image compressed using a format other than the JPEG 2000 format, and includes: allowing a designation of a region of interest for an image file stored in a storage region; determining that the image file corresponds to at least one of a non-compressed file and a compressed file compressed using a format other than the JPEG 2000 format; compressing the image file using the JEPG 2000 format by use of the compression unit in a case where the determination unit determines that the image file corresponds to a non-compressed file, and decompressing the image file by use of the decompression unit before compressing the image file using the JPEG 2000 format by use of the compression unit in a case where the determination unit determines that the image file corresponds to a compressed file compressed using a format other than the JPEG 2000 format; and extracting from the compressed image file compressed by the compression unit blocks corresponding to a region of interest designated by the designation allowing unit and outputting the extracted image file.

One embodiment of an image processing computer program of the present invention is installed in a computer having a compression unit to perform a compression process on an image using a JEPG 2000 format, and a decompression unit to perform a decompression process on an image compressed using a format other than the JPEG 2000 format, and controls the computer to realize: a compression unit to perform a compression process on an image using the JPEG 2000 format; a decompression unit to perform a decompression process on an image compressed using a format other than the JEPG 2000 format; a designation allowing unit to allow a designation of a region of interest for an image file stored in a storage region; a determination unit to determine that the image file corresponds to at least one of a non-compressed file and a compressed file compressed using a format other than the JEPG 2000 format; a compression execution unit to compress the image file using the JEPG 2000 format by use of the compression unit in a case where the determination unit determines that the image file corresponds to a non-compressed file, and decompressing the image file by use of the decompression unit before compressing the image file using the JPEG 2000 format by use of the compression unit in a case where the determination unit determines that the image file corresponds to a compressed file compressed using a format other than the JPEG 2000 format; and an extraction output unit to extract from the compressed image file compressed by the compression unit blocks corresponding to a region of interest designated by the designation allowing unit, and outputting the extracted image file.

A storage medium of the present invention stores the image processing computer program of the present invention.

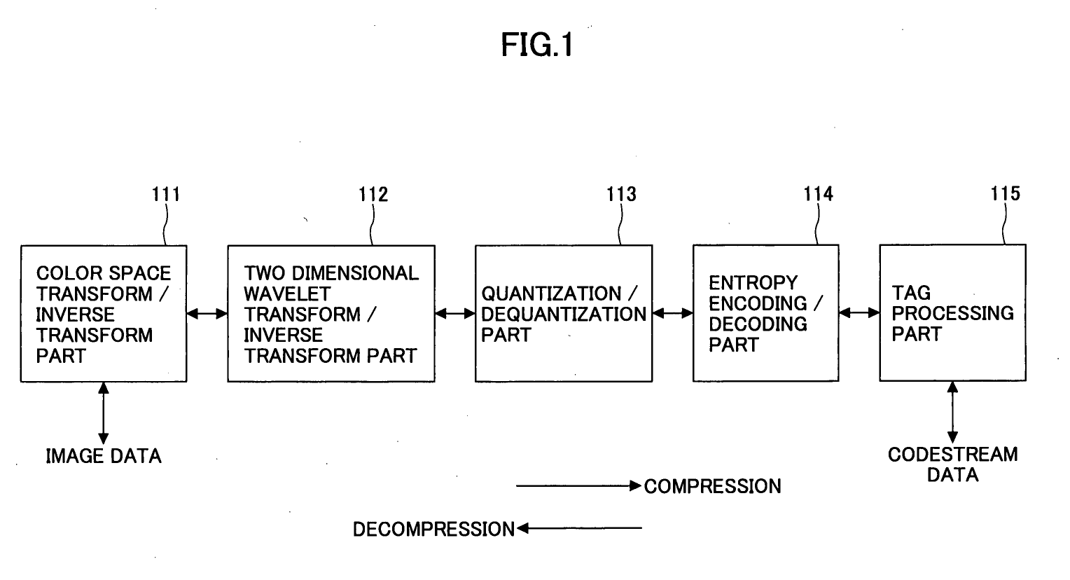

In the following, a preferred embodiment of the present invention is described with reference to FIGS. 1 through 8.

### Outline of JPEG 2000

First, an outline of JPEG 2000 is given below.

JPEG 2000 is a format relating to compression/decompression of image data. A hardware resource is used to compress/decompress image data according to this format In one example, a computer for executing an image processing computer program is used as the hardware resource. Namely, the image processing computer program for executing image data compression/decompression according to the JPEG 2000 format is installed in a storage device such as an HDD of the computer so that the computer can interpret the image processing computer program using a basic architecture built from a CPU and a memory of the computer, perform an image compression process according to JPEG 2000 on an input image, or decompress image data that has been compressed according to the JPEG 2000 format In this example, the storage device of the computer such as the HDD functions as the storage medium that stores the image processing computer program. However, the storage medium storing the image processing computer program is not limited to a storage device of a computer, and may instead be any of a variety of portable recording media such as various optical disks and flexible disks on which information is optically or magnetically recorded.

FIG. 1 is a block diagram showing basic JPEG 2000 algorithms. The blocks in this block diagram represent algorithms each corresponding to respective functions that are to be executed by the computer according to the image processing computer program for compression/decompression of image data according to the JPEG 2000 format

As is shown in FIG. 1, the JPEG 2000 algorithms include a color space transform/inverse transform unit 111, a two-dimensional wavelet transform/inverse transform unit 112, a quantization/dequantization unit 113, an entropy encoding/decoding unit 114, and a tag processing unit 115. Detailed descriptions of these units are given below.

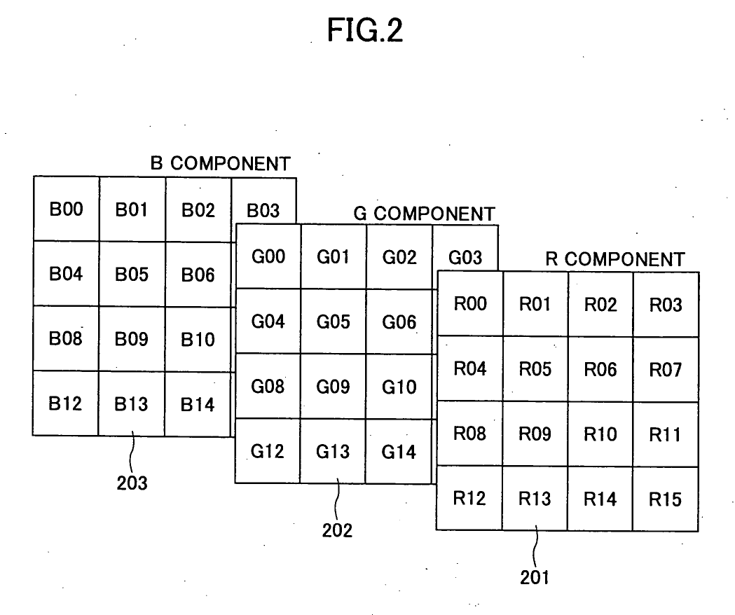

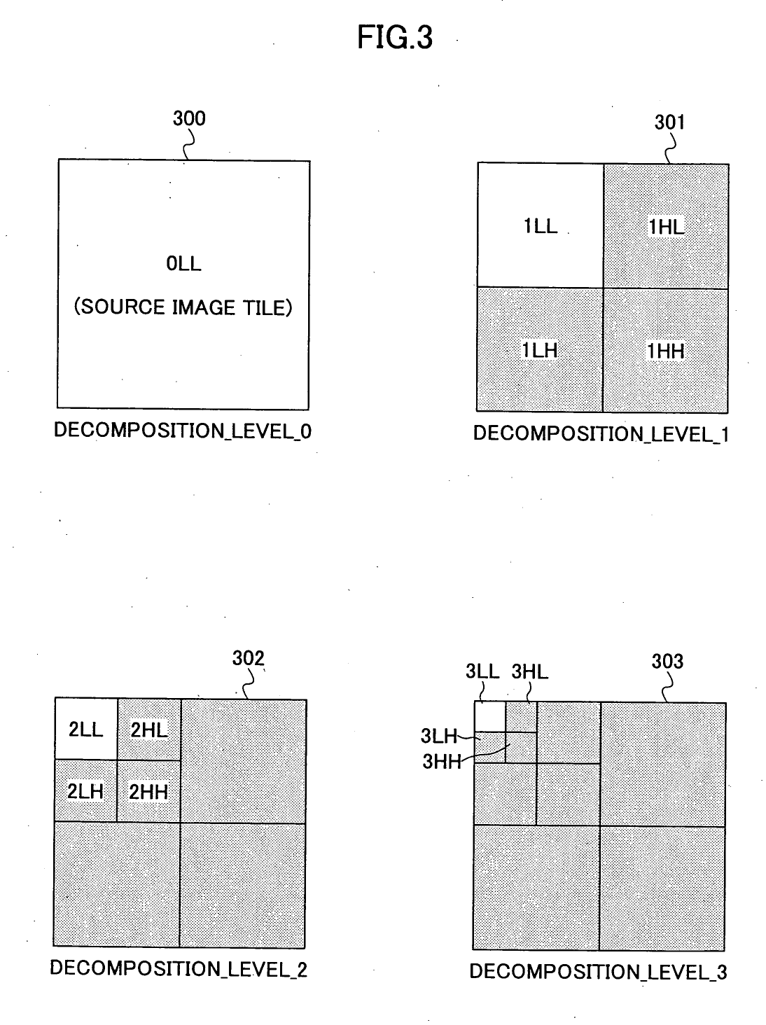

First, the color space transform/inverse transform unit 111 and the two-dimensional wavelet transform/inverse transform unit 112 are described with reference to FIGS. 2 and 3.

FIG. 2 is a diagram illustrating an example of respective components into which a color image corresponding to a source is separated. A color image is generally separated into components such as components R, G, and B according to the RGB primary color system, for example, as is illustrated in FIG. 2. The components R, G, and B of the source image are further divided into rectangular regions corresponding to tiles 201, 202, and 203, respectively. The tiles 201, 202, 203, corresponding to R00, R01, . . . , R15/G00, G01, . . . ,G15/B00, B01, . . . , B15, respectively, for example, each make up a base unit on which a compression/decompression process is performed. In other words, the compression/decompression operation is performed independently on each tile 201, 202, and 203 within each respective components R, G and B.

Upon encoding image data, the data of each of the tiles 201, 202, and 203 are input to the color space transform/inverse transform unit 111 of FIG. 1, and a color space transform process is performed. In this case, according to one embodiment, a reversible color image conversion is performed. This type of reversible conversion process is called RCT (Reversible multiple Component Transformation). Herein, an RGB signal is converted into a YUV signal. Y represents the luminance and U and V each represent a color difference. For example, given that R corresponds to component 0 (R=C0), G corresponds to component 1 (G=C1), and B corresponds to component 2 (B=C2) in RGB, then Y=C0, U=C1, and V=C2 in YUV.

After the color space transform has been performed on the data of each tile 201, 202, and 203 in the above-described manner, a two-dimensional wavelet transform (order conversion) is performed at the two-dimensional wavelet transform/inverse transform unit 112. Herein, the data are spatially divided into frequency bands.

FIG. 3 shows sub bands at each decomposition level for a case in which the decomposition level is 3. The two-dimensional wavelet transform/inverse transform unit 112 performs a two-dimensional conversion process on a source image tile 0LL at decomposition level 0 (300) that is obtained through division of the source image into tiles. In this way, the tile 0LL is divided into sub bands 1LL, 1HL, and 1HH shown at decomposition level 1 (301). Then, the two-dimensional wavelet transform/inverse transform unit 112 performs a further two-dimensional wavelet transform process on the low frequency component 1LL to divide it into sub bands 2LL, 2HL, 2LH, and 2HH shown at decomposition level 2 (302). Then, in a similar manner, the two-dimensional wavelet transform/inverse transform unit 112 performs a two-dimensional wavelet transform process on the low frequency component 2LL to divide it into sub bands 3LL, 3HL, 3LH, and 3HH shown at decomposition level 3 (303). In FIG. 3, the sub bands at each of the decomposition levels that are subjected to encoding are indicated in gray. For example, at decomposition level 3, the sub bands 3HL, 3LH, 3HH, 2HL, 2LH, 2HH, 1HL, 1LH, and 1HH indicated in gray are subjected to encoding, but the sub band 3LL will not be encoded.

Next, at the quantization/dequantization unit 113, after the subject bit to be encoded is determined based on a designated encoding order, a context is generated from the bits surrounding the subject bit to be encoded.

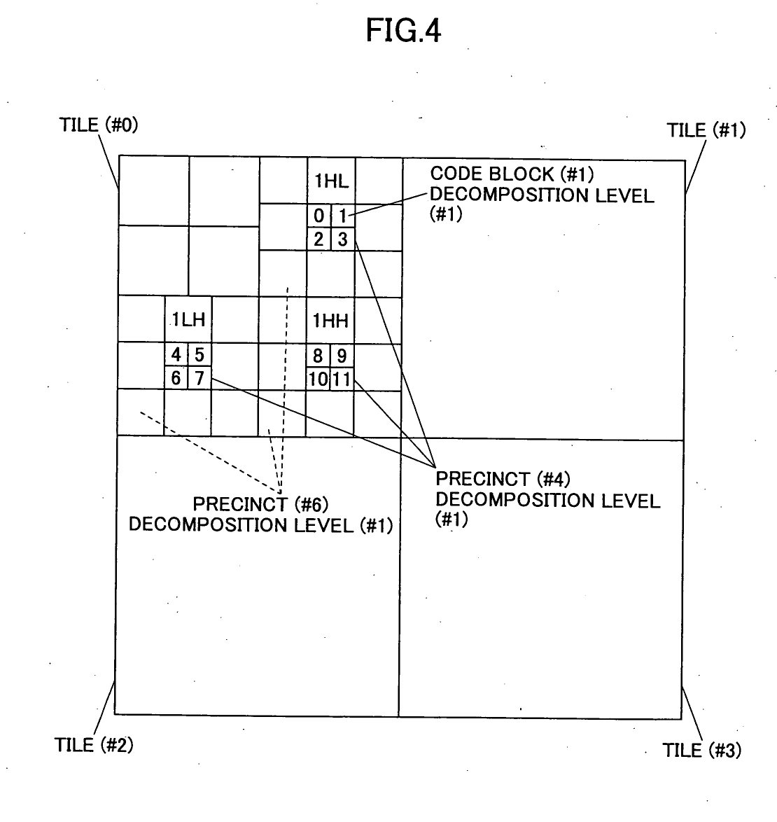

FIG. 4 is a diagram showing examples of precincts. For each sub band, the wavelet coefficients on which quantization processes have been performed are divided into rectangular regions called precincts that do not overlap with one another. The precincts are introduced in order to enable efficient use of the computer memory in the implementation. As is shown in FIG. 4, one precinct is made up of three spatially consistent rectangular regions. Further, each precinct is divided into rectangular code blocks that do not overlap with one another. This code block is used as a base unit upon performing entropy encoding.

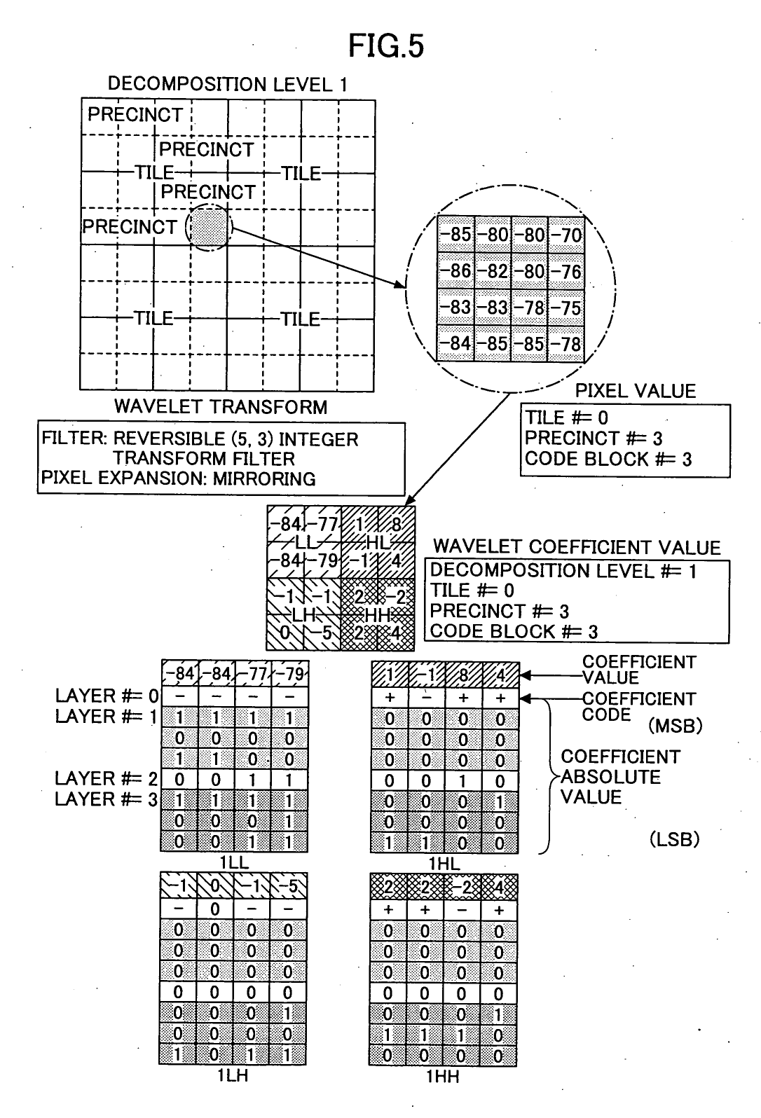

FIG. 5 is a diagram illustrating a process of decomposing the values of the two-dimensional wavelet coefficients obtained from the two-dimensional wavelet transform into bit plane units, and assigning the order of the bit planes for each pixel or code block. Although the coefficient values after the wavelet transform may be directly quantized and encoded, in JPEG 2000, the coefficient values may first be decomposed into bit plane units, and the order of bit planes may be assigned for each pixel or code block in order to improve encoding efficiency. FIG. 5 illustrates an outline of this process. In this exemplary process, a source image of 32×32 pixels is divided into four tiles each having 16×16 pixels, and the sizes of the precincts and the code blocks at decomposition level 1 are 8×8 pixels and 4×4 pixels, respectively. A precinct number and a code block number are assigned according to the raster order. For pixel expansion beyond the tile border, a mirroring method is used to perform a wavelet conversion with a reversible (5, 3) filter to obtain wavelet coefficient values at decomposition level 1. Alternatively, the wavelet conversion may be performed with an irreversible (9, 7) filter.

FIG. 5 also shows a schematic illustration of a representational “layer” of tile0/precinct 3/code block 3. The structure of the layer is easy to comprehend upon viewing the wavelet coefficient values from a horizontal direction (bit plane direction). One layer is made of an arbitrary number of bit planes. In this example, the layers 0, 1, 2, 3 have 1, 3, 1, 3 bit planes, respectively. The layer that includes a bit plane close to the LSB is subjected to quantization first whereas the layer close to the MSB remains without being quantized. The method of discarding layers starting with the layer closest to the LSB is called truncation and this method enables detailed control of the quantization rate.

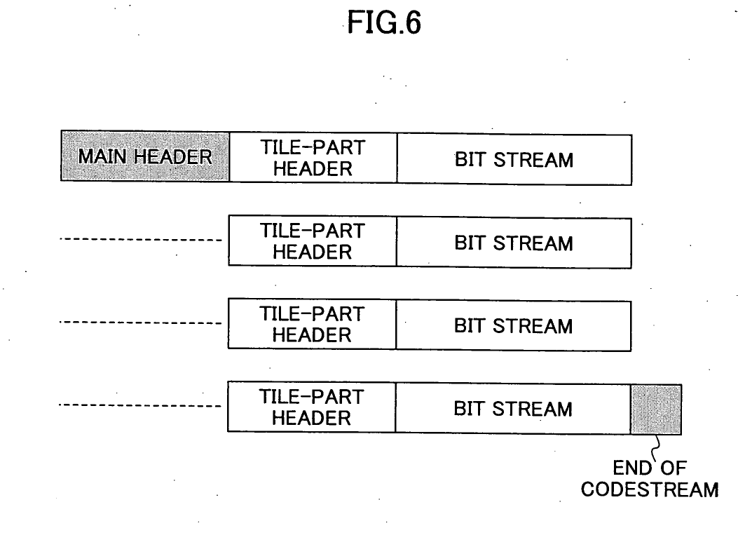

Next, the entropy encoding/decoding unit 114 is described with reference to FIG. 6. FIG. 6 is a diagram illustrating a code stream of encoded image data. In the entropy encoding/decoding unit 114 (refer to FIG. 1), encoding of the RGB components is performed with respect to the tiles 201, 202, and 203 through probability estimation based on the context and the subject bit. In this way, an encoding process is performed for all the components RGB of the source image in units of tiles 201, 202, and 203.

Next, the tag processing unit 115 is described. The tag processing unit 115 performs a process of joining the encoded data from the entropy encoding/decoding unit 114 into one strand of code stream and attaching a tag thereto. Tag information called a header is attached to the front portion of this code stream and to the front portion of each of the component tiles 201, 202, and 203, which is followed by the encoded data of each corresponding tile 201, 202, and 203. Then, a tag is also placed at the end of the code stream.

Upon decoding, the reverse of the above-described processes is performed; that is, image data are generated from the code stream of each of the tiles 201, 202, and 203 within the respective components R, G, B. An outline of this process is described below with reference to FIG. 1. The tag processing unit 115 interprets the tag information attached to an input code stream from outside, decomposes this code stream into code streams corresponding to each of the tiles 201, 202, and 203, within the respective components R, G, B, and performs a decoding process for each of the code streams corresponding to the tiles 201, 202, and 203 within the corresponding RGB components. In this case, the positions of the bits are determined according to the order in which they are to be decoded based on the tag information within the code stream, and in the quantization/dequantization unit 113, the context is generated from the array of surrounding bits of the subject bit position (on which decoding has already been performed). Then, in the entropy encoding/decoding unit 114, decoding is performed through probability estimation based on the context and the code stream so as to generate the subject bit, and the generated bit is written in the subject bit position. Since data decoded in this way are spatially divided for each frequency band, each of the tiles 201, 202, and 203 within the corresponding RGB components of the image data can be restored by performing a two-dimensional wavelet inverse transform at the two-dimensional wavelet transform/inverse transform unit 112. The restored data can then be transformed into the original color system data by means of the color space transform/inverse transform unit 111.

### Image Processing Apparatus, Image Pressing Method, Image Posing Computer Program, and Storage Medium Storing this Image Processing Computer Program

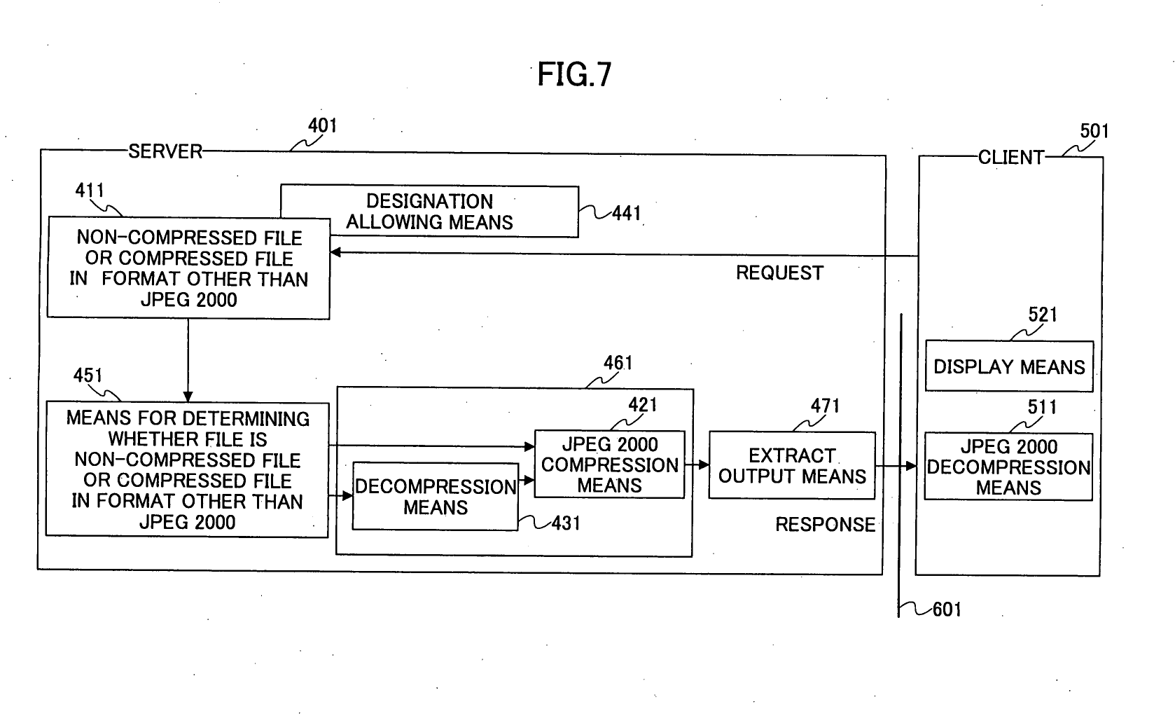

FIG. 7 is a block diagram illustrating the functions of a server corresponding to an image processing apparatus.

According to one embodiment, a client-server system is provided in which a server 401 corresponding to an image processing apparatus and a client 501 are connected via a network 601 so that they are able to realize data communications with one another.

The server 401 and the client 501 are both computers that perform various processes according to application programs operating under operating systems OS (not shown). In other words, the server 401 and the client 501 each implement a microcomputer (not shown), and this microcomputer interprets the image processing computer program, which corresponds to the application program, using its processing function and performs processes according to code described in this image processing computer program. FIG. 7 regards the various processes performed by this microcomputer as functions of the server 401 and the client 501, and represents the various processes performed by the microcomputer as means for realizing these functions.

The image processing program may, for example, be stored in a hard disk of the computer, and when this image processing computer program is started, a portion of this program or the entire program may be loaded into a RAM of the computer. In this sense, the hard disk and RAM of the computer correspond to the storage medium storing the image processing computer program. Moreover, the storage medium storing the image processing computer program may be any kind of storage medium that is able to store data. For example, when considering the distribution of the image processing computer program, it may be convenient to use an optical medium such a CD-ROM, a CD-R, a CD-RW, or a DVD, or a magnetic medium such as an FD, as the storage medium to store the image processing computer program therein.

The client 501 has JPEG 2000 decompression unit 511 and display unit 521 as the means to realize the functions of the image processing computer program. The JPEG 2000 decompression unit 511 consists of the JPEG 2000 algorithms described in the previous section [Outline of JPEG 2000], namely, the color space transform/inverse transform unit 111, the two-dimensional wavelet transform/inverse transform unit 112, the quantization/dequantization unit 113, the entropy encoding/decoding unit 114, and the tag processing unit 115. Herein, the JPEG 2000 decompression unit 511 at least has the function of decompressing image data that have been compressed using the JPEG 2000 format. Thus, the JPEG 2000 decompression unit 511 is at least capable of decompressing image data via the tag processing unit 115, the entropy encoding/decoding unit 114, the quantization/dequantization unit 113, the two-dimensional wavelet transform/inverse transform unit 112, and the color space transform/inverse transform unit 111. Moreover, the client 501 may be arranged to be capable of performing processes for compressing an image file made of non-compressed data using the JEPG 2000 format.

The client 501 has the display unit 521 as another function realizing unit. The display unit 521 realizes the function of outputting various display data on a display (not shown).

Next, the function realizing unit implemented in the server 401 is described below.

The server 401 has a file storage region 411 for storing and saving various files including non-compressed files or compressed files in a format other than the JPEG 2000 format. The server 401 also has a compression unit 421, a decompression unit 431, a designation allowing unit 441, a determination unit 451, a compression execution unit 461, and an extraction output unit 471.

The compression unit 421 performs compression processes on an image in the JEPG 2000 format. Such image compression processes are realized by the JEPG 2000 algorithms described in the previous section [Outline of JPEG 2000], namely, the color space transform/inverse transform unit 111, the two-dimensional wavelet transform/inverse transform unit 112, the quantization/dequantization unit 113, the entropy encoding/decoding unit 114, and the tag processing unit 115. Herein, the compression unit 421 at least has the function of compressing image data in the JPEG 2000 format. Thus, the compression unit 421 is at least capable of compressing image data through the color space transform/inverse transform unit 111, the two-dimensional wavelet transform/inverse transform unit 112, the quantization/dequantization unit 113, the entropy encoding/decoding unit 114, and the tag processing unit 115. Moreover, the server 401 may be arranged to be capable of executing processes for decompressing data compressed in the JPEG 2000 format Further, the compression unit 421 may compress an image file through either lossless compression or lossy compression.

The decompression unit 431 corresponds to function realizing unit that performs processes that are realized by algorithms for decompressing a compressed file that is in a format other than the JPEG 2000 format such as a compressed file in the JPEG format that has been compressed through DCT (Discrete Cosine Transform) coding, for example. This decompression unit 431 is arranged to be capable of decompressing not only compressed files in the JPEG format but other various compressed files as well. As for the decompression methods used herein, it is noted that the decompression unit 431 uses decompression algorithms no different from the respective publicly known decompression algorithms for the compressed files in their various formats, and thereby their descriptions are omitted.

The designation allowing unit 441 allows the designation of a region as a ROI (Region of Interest) for an image file stored in the storage region 411. The method through which the designation allowing unit 441 allows the designation of a region of interest ROI for an image file is not predetermined and any method may be used. For example, the designation allowing unit 441 may attach data for enabling the designation of a region of interest upon transmitting to the client 501 a non-compressed file or a compressed file in a format other than the JPEG 2000 format stored in the storage region 411 to which the client 501 is making access.

After the designation allowing unit 441 allows the designation of the region of interest at the client 501 side, a user may perform operations for designating the region of interest. Then, the designated region of interest may optionally be transmitted to the server 401.

The determination unit 451 determines the type of image file stored in the storage region 411 to which the client 501 is making access; namely, the determination unit 451 determines whether the image file is a non-compressed file or a compressed file compressed in a format other than the JPEG 2000 format. The determination unit 451 makes this determination by referring to a code indicating the file format that is attached to the image file, for example.

When the determination unit 451 determines that the image file corresponds to a non-compressed file, the compression execution unit 461 compresses this image file into the JPEG 2000 format with the compression unit 421, and when the determination unit 451 determines that the image file corresponds to a compressed file compressed in a format other than the JPEG 2000 format, the compression execution unit 461 first decompresses this image file with the decompression unit 431 and then compresses the decompressed file according to the JPEG 2000 format with the compression unit 421. Thus, in the end, the image file is compressed into the JPEG 2000 format.

The extraction output unit 471 extracts from the image file compressed by the compression unit 421 blocks in units of tiles or precincts, for example, corresponding to the region of interest designated by the designation allowing unit 441 and outputs the image data corresponding to the extracted blocks. That is, the extraction output unit 471 extracts, from the two-dimensional data encoded at the entropy encoding/decoding unit 114, image data in units such as tiles or precincts corresponding to the designated region of interest. Then, the extraction output unit 471 transmits the extracted image data in units of tiles or precincts to the client 501 via the network 601. In this case, the extraction output unit 471 may output the image file as a monochrome image, or the extraction output unit 471 may successively output the layers of the image file starting from the uppermost layer. Further, the extraction output unit 471 may be able to freely adjust the resolution of the output image data The data conversion to a monochrome image, the successive data transmission of each layer, and the adjustment of the image resolution may all be performed with ease from the JPEG 2000 data.

Thus, in the present embodiment, the extraction output unit 471 transmits to the client 501 via the network 601 extracted image data in block units such as tiles and precincts as designated by the user. By this arrangement, the communication delivery speed can be increased upon transmitting the image data, and the memory consumption at the client 501 for sending/receiving the image data can be decreased. Further, since the data traffic within the network 601 realizing data communications can be reduced, the load imposed on the network 601 can be reduced.

The compression unit 421 may perform lossless compression processes on an image, and in this case, the compressed image data can be restored to its original image data upon decompression so that reuse of the image data is facilitated. For lossless compression, the compression unit 421 uses a 5×3 filter bank to perform wavelet transform processes. With the 5×3 filter bank, a high quality image that is reversible to its original input image can be obtained within a region designated by this filter.

Alternatively, the compression unit 421 may perform lossy compression processes on the image, and in this case, the image quality (compression rate) may be changed upon transmitting the image data according to the increase/decrease of the number of users being simultaneously supported under a predetermined transmission capacity. In this way, the network 601 can be simultaneously shared by more users compared to the case of sending non-compressed data or lossless compression data. For lossy compression, the compression unit 421 uses a 9×7 filter bank to perform the wavelet transform processes. Thereby, a high quality image close to the original input image can be obtained for the designated region.

The decompression unit 431 is capable of performing decompression processes on an image compressed according to a format other than the JPEG 2000 format, for example, an image compressed according to the DCT (Discrete Cosine Transform) coding format such as JPEG. Thus, the decompression unit 431 is able to handle image data in block units corresponding to that used in the region of interest even for an image compressed according to the DCT (Discrete Cosine Transform) encoding format such as an image compressed in the JPEG format. In this way, for example, the communication speed of delivery can be increased upon transmitting such image data, the memory consumption in the client 501 corresponding to the sending/receiving side can be deceased and further, the traffic on the network 601 realizing the data communications can be reduced so that the load imposed on the network can be reduced.

When the tile is used as the unit of the blocks being extracted and output by the extraction output unit 471, the tiles as the units of the blocks corresponding to the region of interest can be easily extracted from the compressed image data, thereby simplifying the processes of the extraction output unit 471.

When the precinct is used as the unit of the blocks being extracted and output by the extraction output unit 471, the precincts as the units of the blocks corresponding to the region of interest can be easily extracted from the compressed image data, thereby simplifying the processes of the extraction output unit 471. Further, since image degradation characteristically occurring at the borders of the blocks upon high rate lossy compression/decompression can be prevented, a high quality image can be obtained.

Since the extraction output unit 471 is able to freely adjust the resolution of the image file to be output, the extraction output unit 471 may adjust the resolution of the image file to be output according to the resolution of the display (not shown) that is controlled by the display unit 521 of the client 501, for example, so that the resolution of the image file may be adjusted according to the operating environment of the client 501.

When the extraction output unit 471 outputs the image file as a monochrome image, for example, the communication speed may be increased further upon transmitting such monochrome image data, the memory consumption in the client 501 corresponding to the sending/receiving side may be decreased further, and the traffic within the network 601 realizing data communications may be reduced further so that the load on the network 601 is reduced further, while information on the image itself can be accurately conveyed since the monochrome image is able to accurately represent the contour components of an image.

Also, since the extraction output unit 471 is able to successively output the layers in the code stream generated from the compression processes performed by the compression unit 421 starting from the uppermost layer, for example, when a system is provided in which image data can be sent to a plurality of users in response to accesses made by these users, and when the users simultaneously access the same image file via the network 601 so that the transmission band per user is extremely limited, the contours of the overall image can still be rapidly deciphered, and the usage efficiency of the network 601 can be improved.

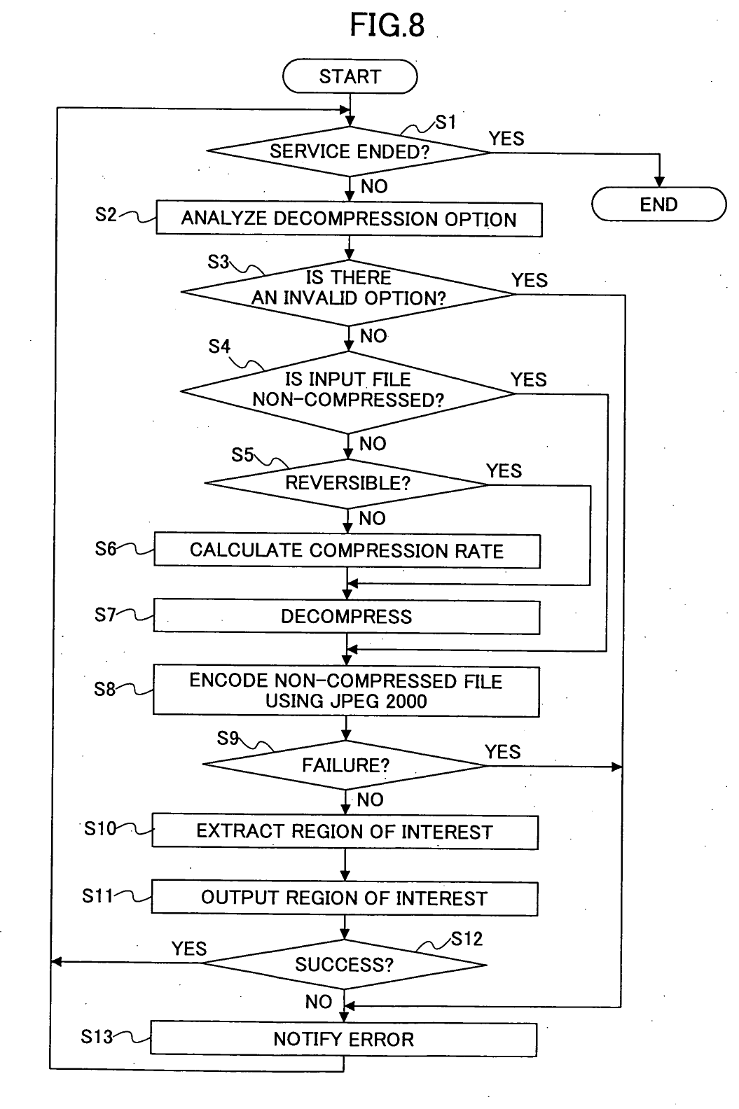

FIG. 8 is a flowchart illustrating the flow of the processes performed by the server 401 corresponding to the image processing apparatus.

First of all, since the process of transmitting an image file from the server 401 of the present embodiment to the client 501 is an event-driven operation that is started in response to a request made by the client 501, the server 401 determines whether the service has been completed (step S1).

Upon determining that the service has not been completed (step S1, N), the server 401 analyzes the option designated by the client 501 (step S2). This option includes data on the region of interest input by the client 501 for the image file that has been allowed the designation of a region of interest by the designation allowing unit 441. It is noted that the allowing of the designation of the region of interest by the designation allowing unit 441 as a designation allowing step is already performed when the client 501 makes access to the image file stored in the storage region 411 of the server 401.

Referring to the analysis results of step S2, in step S3 it is determined whether there are any invalid options, and if an invalid option is detected (step S3, Y), the process proceeds to step S13 wherein data signaling an error is sent back to the client 501. The determination of whether an invalid option exists is realized by the determination unit 451.

On the other hand, when it is determined that there is no invalid option (step S3, N), the process proceeds to a step of determining whether the input file designated by the client 501 is a non-compressed file (step S4). This determination is also realized by the determination unit 451. Thus, the processes of steps S3 and S4 are performed as the determination step.

When it is determined in step S4 that the input file is a compressed file (step S4, N), it is further determined whether the file compression is reversible (step S5). When it is determined that the file compression is irreversible (step 5, N), the compression rate is calculated (step 6), and when it is determined that the file compression is reversible (step 5, Y), the process moves straight on to a step of decompressing the compressed file (step S7). In the case where the file compression is irreversible, the compression rate of the file is calculated based on the image width, height, color component value, bit depth, and file size that are written at the header of the file. Also, it is noted that the present image processing is being described under the assumption that the compressed file handled herein corresponds to a file compressed in a format other than the JEPG 2000 format, and the compressed file is decompressed accordingly depending on its compression format Such decompression of the image file is realized by the compression execution unit 461 and the decompression unit 431. The compression execution unit 461 administers the compression unit 421 to compress a non-compressed file or a file obtained from decompressing a compressed image file (step S8). The compression in this step is performed using the JPEG 2000 format In this way, the processes of steps S5-S8 are performed as the compression step.

Next, it is determined whether the compression into the JPEG 2000 format in step S8 has failed (step S9), and if it is determined to be a failure (step S9, Y), the process proceeds to step S13 wherein data signaling an error is sent back to the client 501. On the other hand, if the process step S8 is determined to be a success (step 9, N), the region of interest designated by the user as an option is extracted from the compressed image file (step S10), and this is output to the client 501 (step S11). These processes are realized by the extraction output unit 471 to complete the extraction output step.

Then, the server 401 makes an inquiry as to whether the data transmission to the client 501 is successful (step S12), and if successful, the process returns to step S1 (step S12, Y). If unsuccessful (step S12, N), the process process to step S13 wherein data signaling an error is sent back to the client 501.

The present application is based on and claims the benefit of the earlier filing date of Japanese Patent Application No. 2002-380039 filed on Dec. 27, 2002, the entire contents of which are hereby incorporated by reference.

What is claimed is:

1. An image processing apparatus comprising:
a compression unit to perform a compression process on an image using a JPEG 2000 format;
a decompression unit to perform a decompression process on an image compressed using a format other than the JEPG 2000 format;
a designation allowing unit to allow allowing a designation of a region of interest for an image file stored in a storage region;
a determination unit to determine that the image file corresponds to at least one of a non-compressed file and a compressed file compressed using a format other than the JEPG 2000 format;
a compression execution unit to compress the image file using the JEPG 2000 format by use of the compression unit in a case where the determination unit determines that the image file corresponds to a non-compressed file, and decompressing the image file by use of the decompression unit before compressing the image file using the JPEG 2000 format by use of the compression unit in a case where the determination unit determines that the image file corresponds to a compressed file compressed using a format other than the JPEG 2000 format; and
an extraction output unit to extract from the compressed image file compressed by the compression unit a plurality of blocks corresponding to a region of interest designated by the designation allowing unit, and outputting the extracted image file.

2. The image processing apparatus as claimed in claim 1, wherein the compression unit performs a lossless compression process on the image.

3. The image processing apparatus as claimed in claim 1, wherein the compression unit performs a lossy compression process on the image.

4. The image processing apparatus as claimed in claim 1, wherein the compression unit performs a wavelet transform process using a 5×3 filter bank.

5. The image processing apparatus as claimed in claim 1, wherein the compression unit performs a wavelet transform process using a 9×7 filter bank.

6. The image processing apparatus as claimed in claim 1, wherein the decompression unit performs a decompression process on an image compressed using a DCT (Discrete Cosine Transform) coding format as the format other than the JEPG 2000 format.

7. The image processing apparatus as claimed in claim 1, wherein the extraction output unit extracts and outputs the blocks in units of tiles.

8. The image processing apparatus as claimed in claim 1, wherein the extraction output unit extracts and outputs the blocks in units of precincts.

9. The image processing apparatus as claimed in claim 1, wherein the extraction output unit adjusts a resolution of the extracted image file to be output.

10. The image processing apparatus as claimed in claim 1, wherein the extraction output unit outputs the extracted image file as a monochrome image.

11. The image processing apparatus as claimed in claim 1, wherein the extraction output unit successively outputs layers included in a code stream that is generated in the compression process performed by the compression unit starting from an upper layer.

12. An image processing method that is realize using, as a hardware resource, a computer having a compression unit to perform a compression process on an image using a JEPG 2000 format, and a decompression unit to perform a decompression process on an image compressed using a format other than the JPEG 2000 format, the method comprising:
allowing a designation of a region of interest for an image file stored in a storage region;
determining that the image file corresponds to at least one of a non-compressed file and a compressed file compressed using a format other than the JPEG 2000 format;
compressing the image file using the JEPG 2000 format by use of the compression unit in a case where the determination unit determines that the image file corresponds to a non-compressed file, and decompressing the image file by means of the decompression unit before compressing the image file using the JPEG 2000 format by means of the compression unit in a case where the determination unit determines that the image file corresponds to a compressed file compressed using a format other than the JPEG 2000 format; and
extracting from the compressed image file compressed by the compression unit a plurality of blocks corresponding to a region of interest designated by the designation allowing unit and outputting the extracted image file.

13. A storage medium storing an image processing computer program that is installed in a computer having a compression unit to perform a compression process on an image using the JEPG 2000 format, and a decompression unit to perform a decompression process on an image compressed using a format other than the JPEG 2000 format, the program controlling the computer to perform a method comprising:
performing a compression process on an image using the JPEG 2000 format;
performing a decompression process on an image compressed using a format other than the JEPG 2000 format;
allowing a designation of a region of interest for an image file stored in a storage region;
determining that the image file corresponds to at least one of a non-compressed file and a compressed file compressed using a format other than the JEPG 2000 format;
compressing the image file using the JEPG 2000 format by use of the compression unit in a case where the image file is determined to correspond to a non-compressed file, and decompressing the image file by use of the decompression unit before compressing the image file using the JPEG 2000 format by use of the compression unit in a case where the image file is determined to correspond to a compressed file compressed using a format other than the JPEG 2000 format; and
extracting from the compressed image file compressed by the compression unit a plurality of blocks corresponding to a designated region of interest and outputting the extracted image file.
